(19) United States
(12) Patent Application Publication
(10) Pub. No.: US 2003/0160507 A1
(43) Pub. Date: Aug. 28, 2003

(54) Articulated vehicle track components and methods and tools for their removal

(76) Inventors: Nathan Johnson, County Durham (GB); Philip John Kite, Northumberland (GB)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/240,186

(22) PCT Filed: Mar. 26, 2001
(86) PCT No.: PCT/GB01/01320

(30) Foreign Application Priority Data
Mar. 31, 2000 (GB) 0007828.7

(51) Int. Cl. B60B 15/00

(52) U.S. Cl. 305/160

(57) ABSTRACT

A ground contacting component for an articulated vehicle track link is retained in the track link by engagement of latterally projecting wings (74) in grooves of the track link. The ground contacting component (70) includes a resilient tongue (78) which engages an end wall of the track link (50) to prevent movement of the ground contacting component out of the track link. The resilient tongue includes a removal tool engagement formation (79) which cooperates with the removal tool (10) of the invention to depress the resilient tongue (78) and to withdraw the ground contacting component from the track link.

The present invention relates to articulated vehicle tracks and to components for such tracks.

The invention relates also to methods and tools for removing the ground contacting components of such tracks from individual track links of the track.

Articulated vehicle tracks are used on a wide range of vehicles, but a principal use is on military vehicles such as tanks and armoured personnel carriers.

Conventional tracks generally comprise a series of track links. Each track link will typically comprise a link plate divided into two sections separated by a spine, each of which sections receives a ground contacting component. Each side of the track link is bored through to allow the passage of elongate track pins. End connectors are used to join individual track links together, thereby to form the links into a track, by clamping together the ends of adjacent track pins. For smaller, lighter weight vehicles, the track link may be in a single section with a single ground contacting component. Adjacent track links may be joined to a common track pin, so that there is, overall, one track pin per track link and the end connectors are not then required.

Contact between the track and the ground is established by means of replaceable ground contacting components. These components must be periodically replaced because of wear and it will often be necessary to exchange one type of ground contacting component for another type in accordance with the ground conditions.

There are two principal types of ground contacting component, that is, road pads and components variously known as grousers, crampons, cleats, mud-grips or ice-rakes. Road pads are mainly used when the vehicle is travelling over hard surfaces such as ordinary roads and where there is adequate grip in normal conditions. Contact with the ground is via a pad of rubber or other elastomeric material. Where the ground conditions are soft or where there is a lack of adhesion with the ground, such as in mud, snow, ice, sand and the like, grousers may be used. In grousers, the pad of elastomeric material is absent and gripping surfaces made of metal or other suitable hard material are provided The gripping surfaces may be covered by a layer of elastomer.

It is readily apparent that, under battlefield conditions, it is essential that road pads and grousers must be capable of being easily and quickly replaced or exchanged, especially as the necessary work may also need to be done in difficult conditions such as darkness and extreme heat or cold.

Providing a reliable means of quickly replacing or exchanging ground contacting components has been a significant problem, which the present invention now seeks to address.

Various means of locating the ground contacting components in the track links are known and one widely employed method comprises providing the ground contacting component with oppositely directed laterally projecting wings or rails which retain the ground contacting component in the track link by sliding into corresponding grooves in the track link. The ground contacting component is provided with a resilient member on its face directed towards the track link and which projects outwardly from that face. When the ground contacting component is fully inserted into the track link the end of the resilient member engages a wall or abutment of the track link to prevent unintentional removal of the ground contacting component from the track link.

Whilst this construction is successful in retaining the ground contacting component in the track link, it has some disadvantages with respect to the removal of the ground contacting component from the track link. In particular, in order to remove the ground contacting component it is necessary to perform two simultaneous operations, that is, to use a suitable first tool to deflect the resilient tongue out of engagement with the wall or abutment (thereby to allow movement of the ground contacting component in the removal direction) and, while maintaining the deflection of the resilient member, to use a further tool to push or lever the component out of the track link.

Not only does this technique require co-ordination and dexterity, but also access to the track by the further tool (and in some cases by the first tool also) is limited by the adjacent vehicle body. Therefore, the ground contacting components can only be replaced whilst they are at the very front or very rear of the track and so can be accessed from all sides. For example, where there are two ground contacting components per track link, the further tool must be applied towards the normally inaccessible central portion of the track link which is only accessible at the very front or very rear of the track. The consequences of this limitation are serious in that the vehicle must be moved frequently to expose the next required ground contacting component. Bearing in mind that, for example, grousers or crampons will often be fitted only to every eighth track link, this means that the time required to exchange the ground contacting components is extended and that one member of the vehicle's crew is continuously detained in driving the vehicle and so cannot assist in exchange or replacement of the ground contacting components. This is somewhat inefficient, especially in wartime.

In order to overcome these deficiencies, the present invention provides a single tool which (in relation to a track having a single ground contacting component per track link, or to the outer components of track having two ground contacting components per track link) can remove the ground contacting component in a simple operation from substantially any point on the track, and a ground contacting component so designed as to be engageable by the tool. In one embodiment, the tool and ground contacting components according to the invention also facilitate removal of inner ground contacting components from track having two such components per track link.

According, to a first aspect of the present invention there is provided a ground contacting component for a track link of an articulated vehicle track, which component comprises a base portion having first and second faces, a ground contacting portion formed at said second face, a resilient member depending outwardly from said first face and operative to co-operate with an abutment surface of the track link to retain the component in the track link and at least one laterally projecting wing formed at each respective side of the component and adapted to be received in a corresponding groove of the track link wherein the resilient member includes a removal tool engagement formation which formation co-operates in use with a removal tool whereby the resilient member may be resiliently deformed to a position at which it no longer co-operates with the abutment surface such that the component may be removed from the track link by the tool

According to a second aspect of the invention there is provided a track link unit of an articulated vehicle track comprising:

a track link comprising a ground contacting component receiving portion and means for articulatedly joining the track link to adjacent track links wherein the ground contacting component receiving portion comprises opposed side walls and an end wall, each of which opposed side walls includes a groove extending along at least part of the length thereof;

and a ground contacting component comprising a base portion having first and second faces, a ground contacting portion formed at said second face, a resilient member depending outwardly from said first face and at least one laterally projecting wing formed at each respective side of the component and operatively received in the corresponding groove of the track link, wherein:

the resilient member co-operates with an abutment surface of the track link to retain the component in the track link and includes a removal tool engagement formation which co-operates in use with a removal tool whereby the resilient member may be resiliently deformed to a position at which it longer cooperates with the abutment surface such that the ground contacting component may be removed from the track link.

In a first preferred embodiment of these aspects of the invention, the respective outwardly extending wings extend over not more than half the length of the component.

In one preferred form of this embodiment, the ground contacting component comprises two laterally extending wings at each side. It is especially preferred in this embodiment that each wing extends over not more than one third of the length of the component such that a gap of about one third of the length of the component is formed between the wings. In this way, the ground contacting component may be removed from the track link with a single movement of the removal tool.

In another preferred embodiment of these aspects of the invention, the ground contacting component further comprises a projecting tongue extending from an end of said component and adapted to be at least partially received in a corresponding recess formed in the end wall of the track link. In this embodiment it is especially preferred that a single wing is formed at each side towards the rear of the ground contacting component (with respect of the insertion direction) and that each wing extends over not more than about one third of the length of the component. This construction facilitates removal of the component with the removal tool and provides improved retention of the component in use.

In another preferred construction according to these aspects of the invention, the ground contacting component further comprises an intermediate plate provided adjacent said second face, which intermediate plate includes the laterally projecting wings. Preferably, the projecting tongue is formed integrally with the intermediate plate.

Alternatively the laterally projecting wings may be formed integrally with the base portion of the ground contacting component.

In an especially preferred construction according to these aspects of the invention, the removal tool engagement formation comprises a hole formed in the resilient member. Such a construction is simple to manufacture and provides easy and reliable operation with the ground contacting component removal tool.

In another preferred construction, the resilient member is formed integrally with the base portion of the ground contacting component such as by deforming a part of the base portion out of the plane of the base portion. Alternatively, a separate resilient member may be attached towards its end to the base portion by suitable fastening means such as, for example, a rivet.

The ground contacting portion may comprise a pad of elastomeric material mounted on or over the second face of the base portion, such that the resulting track is suitable for use on roads or other surfaces with reasonable grip. For use on more difficult surfaces such as ice, snow, sand, mud or the like the ground contacting portion may comprise a hard material with gripping surfaces mounted on or depending from the second face of the base portion. A preferred type of such ground contacting portion includes metal gripping surfaces depending from a metal base portion and which may be covered by a layer of elastomer.

According to a third aspect of the present invention there is provided a tool for removal of a ground contacting component from a track link unit of an articulated vehicle track which tool comprises a handle, a forwardly extending end part for engaging the ground contacting component and a reaction surface disposed between the end part and the handle. Preferably the forwardly extending end part is in the form of a finger portion.

Preferably the reaction surface is substantially flat. It is also preferred that the reaction surface extends at an angle of 15° to 20° with respect to the adjacent part of the handle, more especially at about 17°.

In a variation of the third aspect of the invention there is provided a tool comprising a curved portion disposed between the finger portion and the handle, the outer surface of the curved portion forming the reaction surface.

In another variation of the third aspect of the invention, the tool comprises a first reaction surface and a first extending finger portion disposed at one end of the handle and, at the other end of the handle, a second extending finger portion and a second reaction surface disposed between the second extending finger portion and the handle.

Preferably a curved portion is disposed between the second extending finger portion and the handle, the outer surface of the curved portion forming the second reaction surface.

It is particularly preferred that the curved portion turns though between about 90° and about 180°, especially about 120° to about 180° more especially 150° to about 180° with respect to the adjacent part of the handle.

According to a fourth aspect of the invention there is provided a method of removing the ground contacting component from the track link unit defined above which method comprises providing a tool for removal of the ground contacting component which tool comprises a handle, a forwardly extending end part and a reaction surface disposed between the end part and the handle, inserting a leading end of the tool including the end part into the track link unit and engaging said end part with the removal tool engagement formation of the resilient member, urging the resilient member with said tool to a position at which the path of the resilient member in the removal direction of the ground contacting component is no longer obstructed by the abutment surface of the track link and using said tool to withdraw the ground contacting component from the track link. Preferably, the forwardly extending end part is in the form of a finger portion.

Preferably in executing this method, with the finger portion engaged with the removal tool engagement formation, the reaction surface of the tool bears against a surface of the track link and the handle portion is urged away from the ground contacting surface of the ground contacting component thereby to depress the resilient member and to lever the ground contacting component out of the track link.

For a better understanding of the invention and to show how the same may be carried into effect, reference will be made to the following drawings, in which:

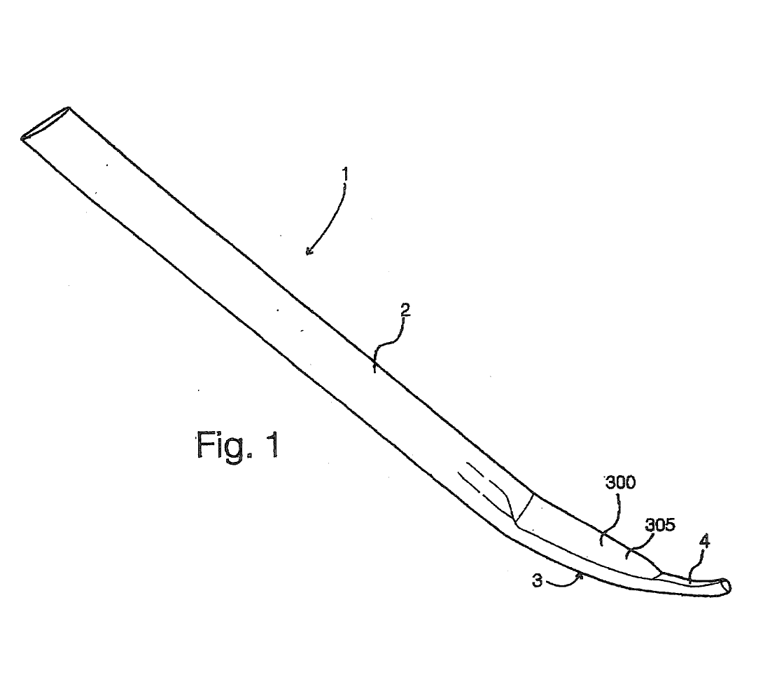

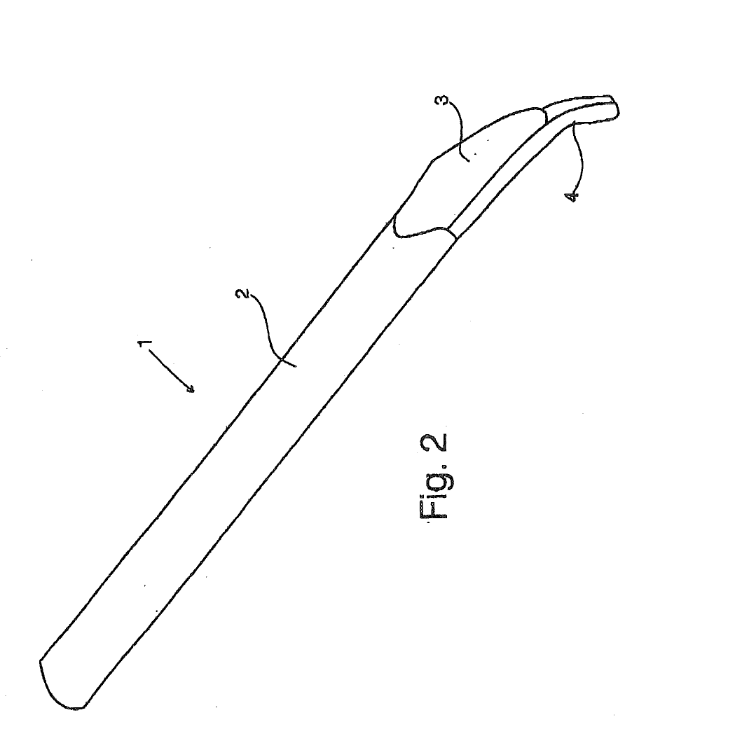

FIGS. 1 and 2 illustrate a first tool according to the present invention;

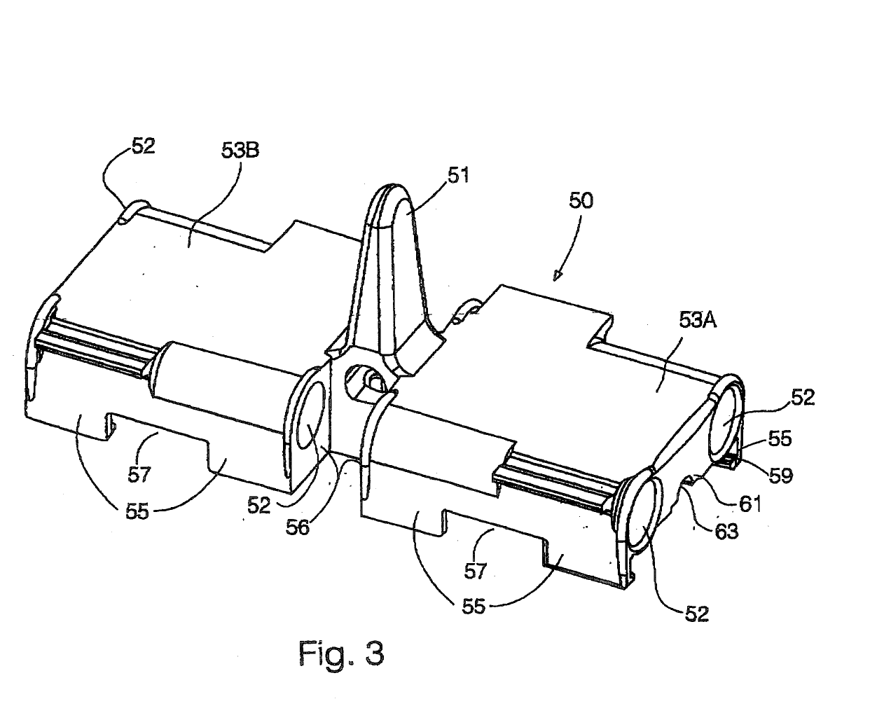

FIG. 3 illustrates a part of a track link of a track link unit according to the invention;

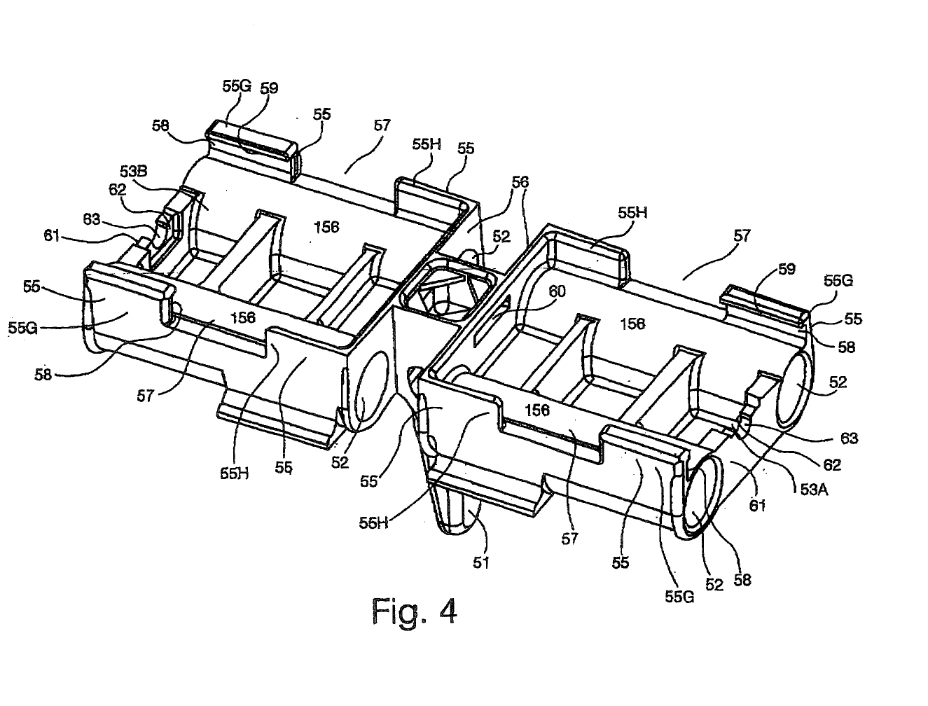

FIG. 4 is an underside view of the track link part of FIG. 3;

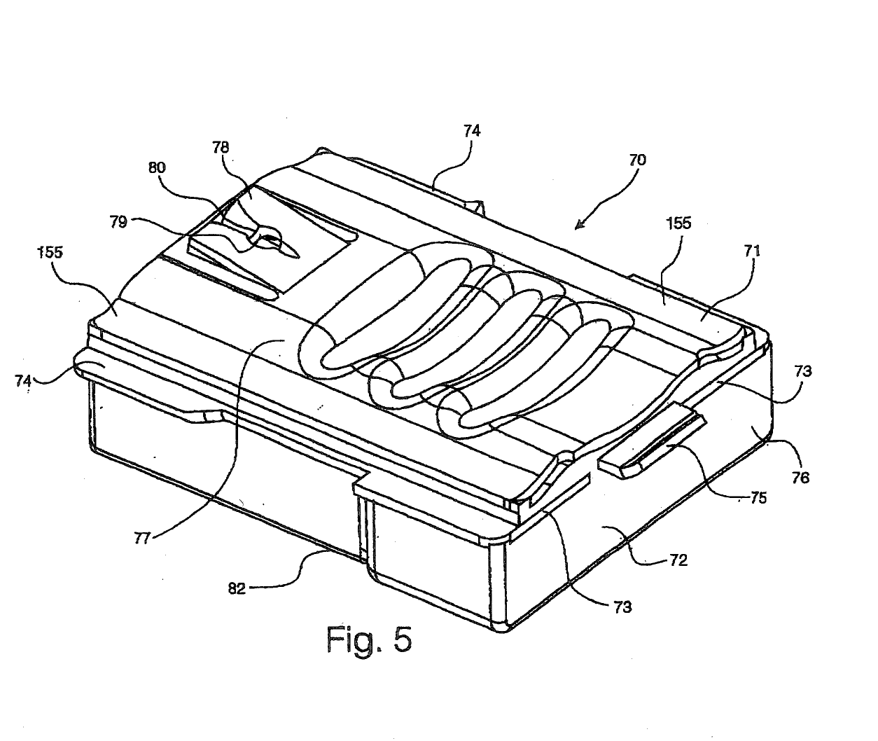

FIG. 5 illustrates a ground contacting component according to the invention, in the form of a road pad;

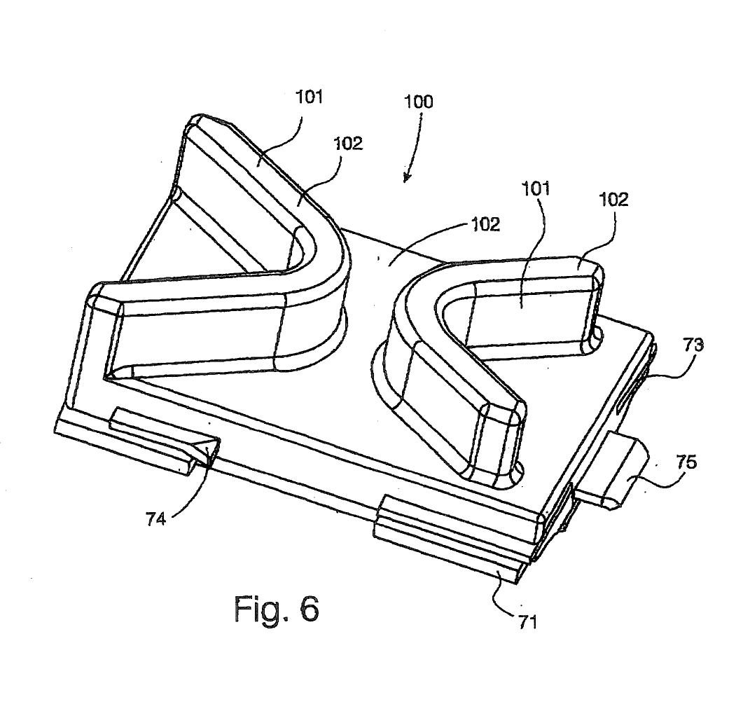

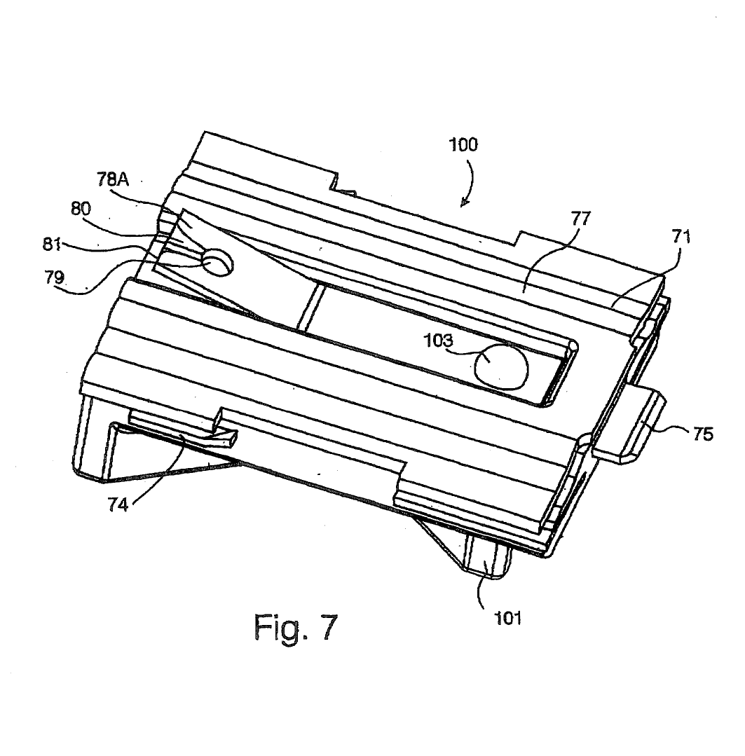

FIGS. 6 and 7 illustrate a ground contacting component according to the invention, in the form of a grouser;

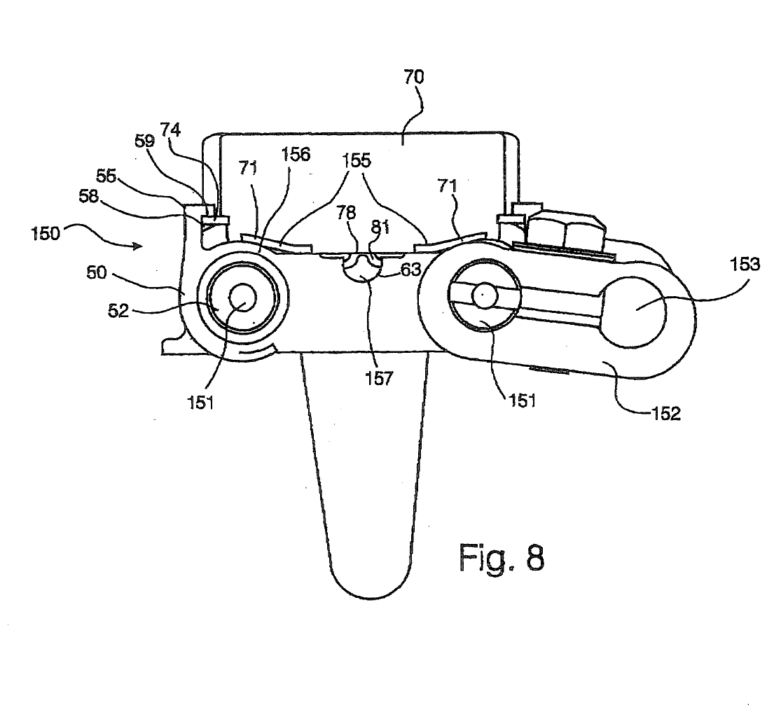

FIG. 8 is an end view of a track link unit according to the invention;

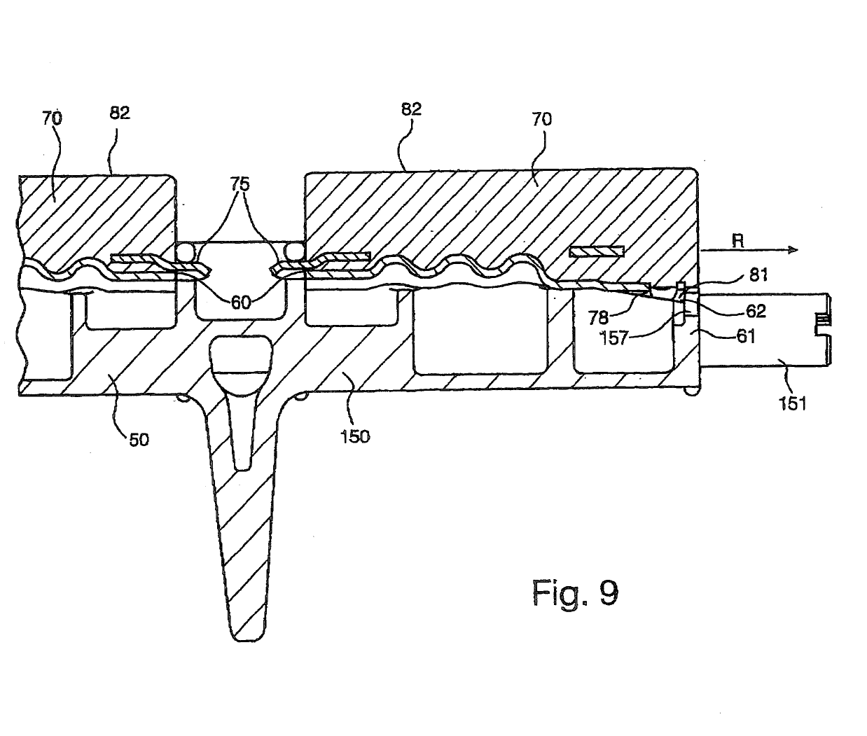

FIG. 9 shows a part of a longitudinal section through the track link unit of FIG. 8;

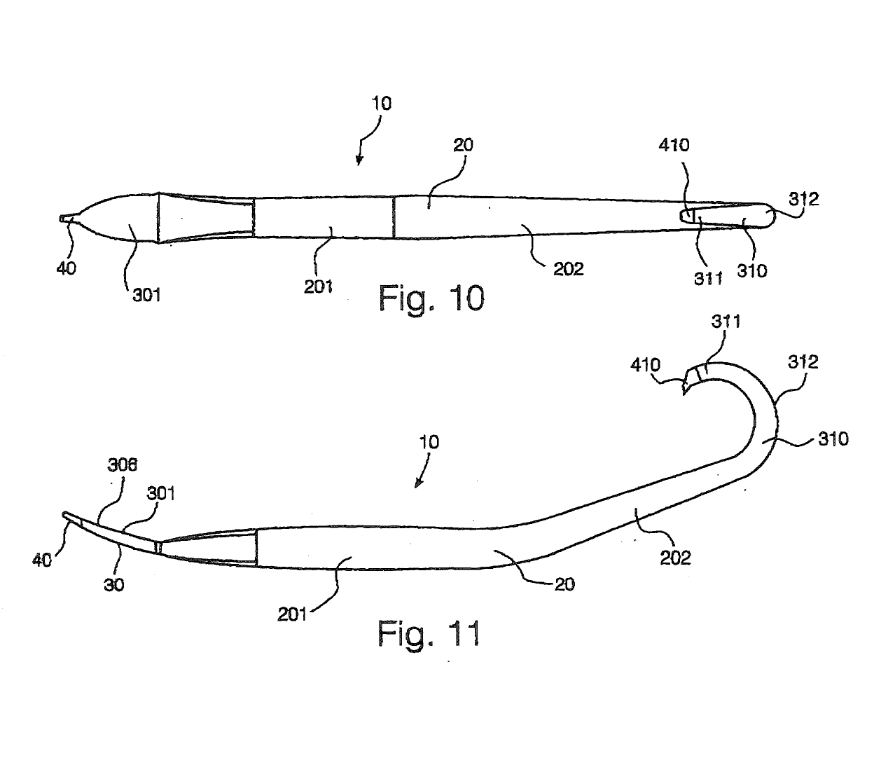

FIGS. 10 and 11 illustrate a variation of the tool according to the invention; and

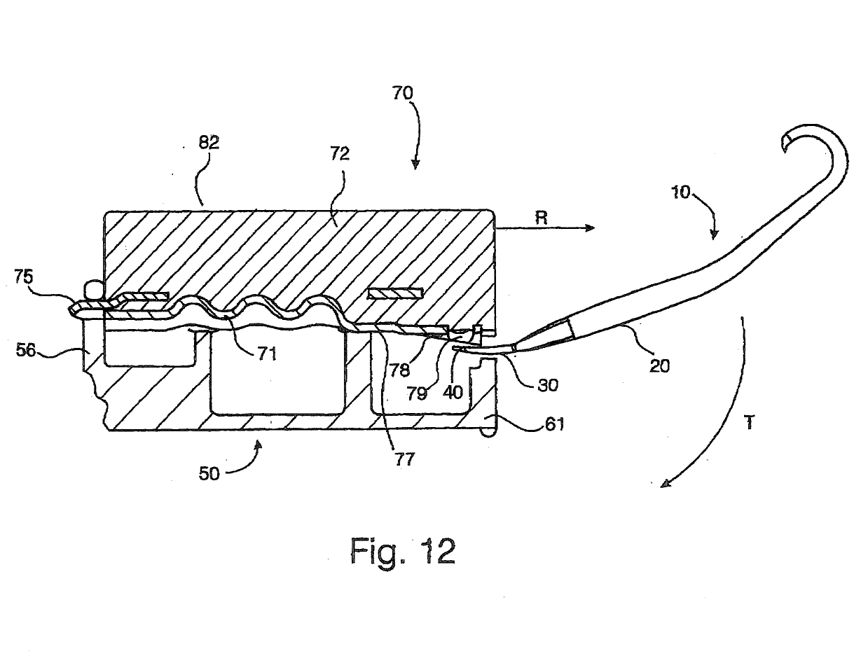

FIG. 12 illustrates the use of the removal tool in removing a ground contacting component.

Referring now to FIGS. 1 and 2, the tool 1 comprises a handle portion 2, a reaction surface part 300 with a reaction surface 3 and a finger portion 4. It can be seen that the reaction surface 3 is disposed at one end of the handle portion 2 and that the finger portion 4 depends from the reaction surface part 300. The angle of the reaction surface 3 with respect to the adjacent part of the handle portion 3 should be selected in accordance with the particular ground contacting component and track links with which the tool is to be used, and so may vary widely. However, the angle of the reaction surface 3 with respect to the adjacent part of the handle portion will generally be between 15° and 20°, more especially about 17°. Similarly the angle of the finger portion 4 with respect to the reaction surface 3 and/or its degree of curvature may be selected in accordance with the particular components with which it is to be used.

As will be explained in more detail later, a leading part of the tool 1 including at least the finger portion 4 is inserted into a track link unit carrying a ground contacting component. The leading part of the tool 1 engages with the resilient member of the ground contacting component and this resilient member is depressed by the tool 1 so that it no longer prevents removal of the ground contacting component from the track link unit. This is achieved by a levering action of the tool 1 in which the reaction surface 3 acts on an adjacent part of the track link unit, so that the part acts as a sort of fulcrum. By continuing the levering action after the resilient member has been depressed, the ground contacting component is caused to slide out of the track link unit. Thus the ground contacting component may be removed in one simple operation.

Referring now to FIGS. 3 and 4, the track link part 50 which is generally in the form of a metal casting (although other manufacturing techniques and materials may be employed) includes a shoulder 51 which provides lateral location with respect to the vehicle in use of the track, through bores 52 which receive track pins by which individual track links are connected together and which provide the articulation between the track links, and ground contacting component receiving portions 53A and 53B disposed at either side of the shoulder 51. The ground contacting component receiving portions 53A, 53B are generally identical to each other. Each ground contacting component receiving portion 53A, 53B has opposed side walls 55 and an end wall 56. The ground contacting component receiving portions 53A, 53B have an open face opposite the end wall 56 through which open face the ground contacting component is received.

As can be seen in FIG. 4, each side wall 55 occupies only a part of the length of the ground contacting component receiving portion 53A, 53B, such that each side wall includes a gap 57. Each side wall part 55G includes a groove 58 extending along its length into which a laterally projecting wing of a ground contacting component is received. If desired, a corresponding groove may be provided on the side wall parts 55H, but this is not necessary in the particular embodiment illustrated.

Ground contacting components are illustrated in FIGS. 5, 6 and 7. In FIGS. 6 and 7 the ground contacting component is a grouser which is illustrated with the ground contacting parts directed respectively upwardly and downwardly. FIG. 5 illustrates a road pad and, in this illustration, the ground contacting part is directed downwardly.

Referring now in particular to FIG. 5, the road pad 70 comprises a base portion 71 in the form of a backing plate of metal or other suitable material A body of rubber or other elastomeric material 72 which forms the road contacting part of the road pad is attached to one face of the backing plate 71 by any suitable means, as is well known in the art. In the embodiment illustrated in FIG. 5, an intermediate plate 73 is provided which is disposed between the backing plate 71 and the bulk of the elastomeric material 72. The intermediate plate 73 may include holes or other openings through which the elastomeric material 72 penetrates in order to facilitate attachment of the elastomeric material 72 to the backing plate 71. Depending from the intermediate plate 73 are oppositely directed laterally projecting wings 74. In alternative constructions the intermediate plate 73 may be absent and the laterally projecting wings 74 may be formed integrally with the base portion 71.

Also depending from the intermediate plate 73 is a projecting tongue 75 which projects from the end face 76 of the road pad 70, generally in the direction in which the road pad 70 is inserted into the track link. Again, in constructions where the intermediate plate 73 is absent, the projecting tongue 75 may be formed integrally with the base portion 71.

On the exposed outer face 77 of the base portion 71 a resilient member 78 is provided. The resilient member 78 projects outwardly from the base portion 71 and may in use be resiliently depressed so that it lies flush, or more nearly flush with the outer face 77 of the base portion 71. The member 78 is resilient in that, when not being depressed, it returns to the configuration illustrated in FIG. 5.

The resilient member 78 includes a removal tool engagement formation 79 which, in the embodiment illustrated, is principally in the form of a hole in the resilient member 78. The resilient member 78 also includes a recess or depression 80 which has a generally frusto-conical configuration and which acts as a guide for the projecting finger 4 of the removal tool 1 to facilitate the insertion of the tool 1. It may be noted that other removal tool engagement formations 79 are possible, such as, for example, an abutment, ridge or depression formed on or in the resilient member 78 and that the recess or depression 80 may take any convenient shape to conform with the removal tool 1.

The ground contacting component 100 of FIGS. 6 and 7 is a grouser for use in conditions of poorer grip. Many parts of the grouser 100 are identical or functionally identical to corresponding parts of the road pad 70 and are therefore given identical reference numbers and are not described further.

The grouser 100 includes gripping parts 101 depending from or mounted on the base portion 71 which engage the ground and provide traction. These gripping parts 101 will normally be made from metal, but other suitable hard and durable materials may be used. The gripping parts 101 and the adjacent surface 102 may be covered by a layer of elastomer.

The grouser 100 also includes a resilient member 78A which is functionally identical to the resilient member 78 of the road pad of FIG. 5. However, whereas the resilient member 78 is formed integrally with and depends from the base portion 71, the resilient member 78A is formed as a separate component which is fastened to the base portion 71 by suitable means, in this case being a rivet 103. Clearly, the road pad 70 may alternatively have a separate resilient member 78A and the grouser 100 may alternatively be formed with integral resilient member 78.

FIG. 8 shows an end view of a track link unit and FIG. 9 shows a section through a track link unit, each according to the invention and in this case including a road pad 70. The track link unit 150 includes a track link part 50 which, in combination with the road pad 70 can be said to form a track link unit As indicated in relation to FIGS. 3 and 4, the track link part 50 includes through bores 52 which in FIGS. 8 and 9 contain track pins 151. As can be seen in FIG. 8, an end connector 152 is attached to one track pin 151 and itself includes a bore or cavity 153 for receiving a track pin of an adjacent track link (not illustrated). The end connector 152 includes a through bolt 154 which is received in a bore perpendicular to the axis of the track pins 151 and which, because of the loop-type construction of the end connector, enables the end connector 152 to be tightened onto, and so firmly attached to, the track pins 151. Other constructions of end connector and means of attaching the end connector to the track pins are known and may be used.

As may best be seen from FIG. 8, the road pad 70 is received in ground contacting component receiving portions 53A/53B such that side parts 155 of the outer face 77 of the base portion 71 lie against the outer surface 156 of the track pin bores 52, and, the projecting wings 74 are received in grooves 58 of side walls 55. The ground contacting component 70, 100 may usefully be constructed so that, in use, the projecting wings 74 are urged against the lip 59 of the groove 58. Thus, the projecting wings 74 and grooves 58 serve to retain the ground contacting component 70, 100 in the track link.

A preferred embodiment of the invention, as illustrated in the drawings, includes a further means of locating and retaining the ground contacting component 70, 100 in the track link. Thus, the ground contacting component 70,100 includes projecting tongue 75 which, when the ground contacting component 70,100 slides into the track link, is received in slot 60 of the track link part 50. This construction is particularly beneficial where the ground contacting component includes only short projecting wings 74 (occupying, say, about one third of the length of the ground contacting component 70, 100) and disposed towards the rear, that is, at the end nearer to the resilient member 78 and distant from the projecting tongue 75.

The resilient member 78 (78A) serves to prevent unintentional withdrawal of the ground contacting component 70, 100 from the track link. As the ground contacting component 70,100 is made to slide into the track link, the resilient member 78 (78A) is deflected by outer end wall 61 of the track link unit part 50 so that it lies flush or more nearly flush with the base portion 71. As the ground contacting component 70,100 reaches its position of use, the trailing edge 81 of the resilient member 78 (78A) passes the inner edge of the end wall 61 and so resiliently returns to its original configuration. The trailing edge 81 will thus abut the inner face 62 of wall 61 if the ground contacting. component 70,100 is moved in a removal direction substantially parallel to the axes of the track pins 151 thereby preventing removal of the ground contacting component from the track link. In other words, the resilient member 78 (78A) has a latching action to retain the ground contacting component 70, 100 in the track link. Therefore, in order to remove the ground contacting component 70, 100 it is necessary to deflect the resilient member 78 (78A) out of engagement with the wall 61 by depressing the resilient member 78 (78A) so that it lies flush (or more nearly flush) with the base portion 71. The ground contacting component 70, 100 must be made to slide in the removal direction (arrow R) whilst maintaining the resilient member 78 (78A) in the depressed condition until such time as it has passed outer end wall 61.

FIGS. 10 and 11 illustrate a variation of the ground contacting component removal tool according to the present invention. In FIGS. 10 and 11, the tool 10 includes a handle portion 20, a reaction surface part 301 with a reaction surface 30 and a finger portion 40. The reaction surface part 301 and the finger portion 40 are functionally the same as the reaction surface part 3 and finger portion 4 of the tool of FIGS. 1 and 2. The handle portion 20 includes a portion 201 adjacent the reaction surface part 301 and an inclined portion 202 distant from the reaction surface 30. The handle portion 2, 20, (201, 202) is preferably of a sufficient length and thickness such that it may be gripped comfortably by a person with gloved hands (and with both hands), as may be required, for example, in conditions of severe cold, or to protect the operator from injury. A diameter of about 30 mm is preferred.

As its end distant from the reaction surface part 301, the tool according to this embodiment of the invention includes a curved portion 310 depending from, or as a continuation of, handle portion 20. In the illustrated embodiment, the curved portion 310 turns through approximately 180° with regard to the adjacent part 202 of the handle portion 20, although the actual amount will depend on the particular ground contacting component and track link with which the tool is intended to be used. At the end 311 of the curved portion 310 distant from the handle portion 20, a second finger portion 410 is formed. The parts of the tool 20, 310, 311 and 410 are adapted for removing inner ground contacting components (with respect of the vehicle body) of tracks having two ground contacting components per link. The outer surface 312 of the curved portion 310 forms a reaction surface during removal of the ground contacting component, as will be described more fully below.

The method of use of the removal tool according to the invention will now be described in more detail with particular reference to FIGS. 8, 9 and 12 and in relation to a track comprising a single ground contacting component per track link or to the outer components of track comprising two ground contacting components per track link.

As noted above, in order to remove the ground contacting component 70, 100 it is necessary to deflect the resilient tongue 78 (78A) out of engagement with end wall 61 and, whilst maintaining the resilient member 78 (78A) in its deflected condition, to slide the ground contacting component outwardly in the direction of arrow R (FIG. 9). The tool of the invention enables this operation to be carried out simply and, generally, in a single step.

In particular, in order to remove the ground contacting component 70,100 a leading part of the tool 1,10 including the finger portion 4,40 and a portion of the reaction surface part 300,301 is inserted through the hole 157 formed by recess 63. When the tool 4,40 has been inserted to an appropriate distance, the handle portion 2,20 is moved generally as indicated by arrow T (FIG. 12), that is, in a direction generally away from the ground contacting surface 82,104 of the ground contacting component 70,100. The reaction surface 3,30 then comes into contact (or may already be in contact) with the end wall 61 in the area of recess 63,50 that the end wall 61 acts as a fulcrum. As the handle portion 2,20 is moved further, the leading part of the tool 1,10 which is within the ground contacting component 70,100 is raised so that an area of the upper surface 305,306 of the reaction surface part 300,301 or of finger 4,40 is urged against the end region of the resilient member 78 (78A) and the finger 4,40 enters the hole 79. Continued movement of the handle portion 2,20 in the direction of arrow T causes the resilient member 78 (78A) to be depressed (urged upwardly in FIG. 12) until it is clear of end wall 61. At this point, movement of the ground contacting component 70,100 in the direction of arrow R (FIGS. 8 and 12) is no longer constrained by the abutting of the end of the resilient member 78 (78A) against the end wall 61. Further movement of the handle portion 2,20 in the direction of arrow T causes the finger portion 4,40 to act on the side wall of member 78 (78A) which defines the hole 79 so that the ground contacting component 70,100 is urged and so moves in the direction of arrow R. In this way, the projecting tongue 75 is disengaged from slot 60 and wings 75 slide out of grooves 55 so that the ground contacting component 70,100 can be removed from the track link.

The method of use of the removal tool illustrated in FIGS. 11 and 12 for removing inner ground contacting components from a track having two such components per tract link is essentially similar. In this case, the end 311 and finger portion 410 of the curved portion 310 are inserted into the hole 157. In this orientation, the reaction surface part 301 lies generally over the ground contacting surface 82. Movement of the handle portion 20 in a direction away from the ground contacting surface 82 causes a part of the outer surface 312 to come into contact with wall 61 in recess 63 and to act as a reaction surface. Further movement of the handle portion 20 causes the resilient tongue 78 (78A) to be depressed, the finger portion 410 to enter the hole 79 and the ground contacting component 70, 100 to slide out of the track link in a similar manner to that described above in respect of outer or single ground contacting components. It will be appreciated that the present invention is not limited to tool having both the reaction surface part 301 and finger 40 and also the curved portion 310 and finger portion 410. Tools primarily intended for removal of inner ground contacting components need not have the reaction surface part 301 and finger portion 40.

In a particularly preferred form of the invention, the length and disposition of the projecting wings 74 and the grooves 58 are so selected that a single movement or stroke of the removal tool moves the ground contacting component 70, 100 in the removal direction R through a sufficient length such that the projecting wings 74 become disengaged from the grooves 58. In this way, after a single stroke or movement of the tool 1, 10 the ground contacting component can simply be lifted out of the track link unit part 50. Clearly, in order to achieve this result, the length through which the ground contacting component 70, 100 must be moved in order for the projecting wings 74 to become disengaged from the grooves 58 should ideally be made as short as possible and for this reason, the projecting wings 74 are made to have a relatively short length of, say, not more than about one third of the length of the ground contacting component. The actual length through which the ground contacting component must be moved will depend on the particular design, but about 50 mm is typical. In these circumstances, the provision of the projecting tongue 75 which sits in the recess 60 is particularly advantageous in providing an additional location means for the ground contacting component 70, 100, to compensate for the shorter length of the projecting wings 74.

In the case where the side walls 55H also include a groove similar to groove 58 and the ground contacting component 70, 100 includes projecting wings at the leading end of the component (with respect to direction R) similar to projecting wings 74, the ground contacting component 70, 100 may still be removed by a single stroke or movement of the tool 1, 10 since the projecting wings at the leading end, after the single stroke or movement of the tool 1, 10 can lie in respective gaps 57 so that, again, the ground contacting component 70, 100 may simply be lifted out of the track link unit part 50. However, increasing the overall length of the projecting wings can be disadvantageous since the frictional resistance to movement of the ground contacting component 70, 100 in the removal direction R (and also in the insertion direction) can thereby be increased.

1. A ground contacting component for a track link of an articulated vehicle track, which component comprises a base portion having first and second faces, a ground contacting portion formed at said second face, a resilient member depending outwardly from said first face and operative to co-operate with an abutment surface of the track link to retain the component in the track link and at least one laterally projecting wing formed at each respective side of the component and adapted to be received in a corresponding groove of the track link wherein the resilient member includes a removal tool engagement formation which formation co-operates in use with a removal tool whereby the resilient member may be resiliently deformed to a position at which it no longer co-operates with abutment surface and the component may be removed from the track link by the tool.

2. A track link unit of an articulated vehicle track comprising:
a track link comprising a ground contacting component receiving portion, and means for articulatedly joining the track link to adjacent track links wherein the ground contacting component receiving portion comprises opposed side walls and an end wall, each of which opposed side walls includes a groove extending along at least part of the length thereof; and
a ground contacting component comprising a base portion having first and second faces, a ground contacting portion formed at said second face, a resilient member depending outwardly from said first face and at least one laterally projecting wing formed at each respective side of the component received in the corresponding groove of the track link, wherein:
the resilient member co-operates with an abutment surface of the track link to retain the component in the track link and includes a removal tool engagement formation which co-operates in use with a removal tool whereby the resilient member may be resiliently deformed to a position at which it no longer co-operates with the abutment surface and the ground contacting component may be removed from the track link by the tool.

3. A ground contacting component as claimed in claim 1 or a track link unit as claimed in claim 2 wherein the respective outwardly extending wings extend over not more than half the length of the component.

4. A ground contacting component as claimed in claim 1 or a track link unit as claimed in claim 2 wherein the ground contacting component comprises two laterally extending wings at each side.

5. A ground contacting component or a track link unit as claimed in claim 4 wherein each wing extends over not more than one third of the length of the component such that a gap of about one third of the length of the component is formed between the wings.

6. A ground contacting component as claimed in any of claims 1 to 5 or a track link unit as claimed in any of claims 2 to 5 wherein the ground contacting component further comprises a projecting tongue extending from an end of said component and adapted to be at least partially received in a corresponding recess of the track link.

7. A ground contacting component as claimed in any preceding claim or a track link unit as claimed in any of claims 2 to 6 wherein the ground contacting component further comprises an intermediate plate provided adjacent said second face, which intermediate plate includes the laterally projecting wings.

8. A ground contacting component or a track link unit as claimed in claim 6 or 7 wherein the projecting is tongue is formed integrally with the intermediate plate.

9. A ground contacting component as claimed in any of claims 1 to 6 or a track link unit as claimed in any of claims 2 to 6 wherein the laterally projecting wings are formed integrally with the base portion of the ground contacting component.

10. A ground contacting component as claimed in any preceding claim or a track link unit as claimed in any of claims 2 to 9 wherein the removal tool engagement formation comprises a hole formed in the resilient member.

11. A ground contacting component as claimed in any preceding claim or a track link unit as claimed in any of claims 2 to 10 wherein the resilient member is formed integrally with the base portion of the ground contacting component.

12. A ground contacting component as claimed in any of claims 1 to 10 or a track link unit as claimed in any of claim 2 to 10 wherein the resilient member is attached towards its end to the base portion by fastening means.

13. A ground contacting component as claimed in any preceding claim or a track link unit as claimed in any of claims 2 to 12 wherein the ground contacting portion comprises a pad of elastomeric material.

14. A ground contacting component as claimed in any of claims 1 to 12 or a track link unit as claimed in any of claims 2 to 12 wherein the ground contacting portion comprises a hard material with gripping surfaces.

15. A tool for removal of a ground contacting component from a track link unit of an articulated vehicle track which tool comprises a handle, a forwardly extending end part for engaging the ground contacting component and a reaction surface disposed between the finger portion and the handle.

16. A tool as claimed in claim 15 wherein the end part is in the form of a finger portion

17. A tool as claimed in claim 15 or 16 wherein the reaction surface is substantially flat.

18. A tool as claimed in claim 15, 16 or 17 wherein the reaction surface extends at an angle of 15° to 20° with respect to the adjacent part of the handle portion.

19. A tool as claimed in claim 15 or 16 comprising a curved portion disposed between the end part and the handle, the outer surface of the curved portion forming the reaction surface.

20. A tool as claimed in claim 16 comprising a first reaction surface and a first extending finger portion disposed at one end of the handle and, at the other end of the handle, a second extending finger portion and a second reaction surface disposed between the second extending finger portion and the handle.

21. A tool as claimed in claim 20 comprising a curved portion disposed between the second extending finger portion and the handle, the outer surface of the curved portion forming the second reaction surface.

22. A tool as claimed in claim 19 or claim 20 wherein the curved portion turns though approximately 180° with respect to the adjacent part of the handle.

23. A method of removing the ground contacting component from the track link unit of claim 2 which method comprises providing a tool for removal of the ground contacting component which tool comprises a handle, a forwardly extending end part and a reaction surface disposed between the end part and the handle, inserting a leading end of the tool including the end part into the track link unit and engaging said end part with the removal tool engagement formation of the resilient member, urging the resilient member with said tool to a position at which the path of the resilient member in the removal direction of the ground contacting component is no longer obstructed by the abutment surface of the track link and using said tool to withdraw the ground contacting component from the track link.

24. A method as claimed in claim 23 wherein the forwardly extending end part is in the form of a finger portion.

25. A method as claimed in claim 24 wherein, with the finger portion engaged with the removal tool engagement formation, the reaction surface of the tool bears against a surface of the track link and the handle portion is urged away from the ground contacting surface of the ground contacting component thereby to depress the resilient member
and to lever the ground contacting component out of the track link.

26. A ground contacting component substantially as hereinbefore described with reference to any of FIGS. 5 to 9 or 12.

27. A track link or track link unit substantially as hereinbefore described with reference to any of FIGS. 3, 4, 8, 9 or 12.

28. A tool substantially as hereinbefore described with reference to any of FIGS. 1, 2, 10, 11 or 12.

29. A method substantially as hereinbefore described with reference to any of FIGS. 1 to 12.
